(19) United States
(12) Patent Application Publication
(10) Pub. No.: US 2023/0293921 A1
(43) Pub. Date: Sep. 21, 2023

(54) LOW NOISE NOZZLE ASSEMBLY FOR FIRE SUPPRESSION SYSTEM

(71) Applicant: Carrier Corporation, Palm Beach Gardens, FL (US)

(72) Inventors: Karen Bouchard, Ayer, MA (US); Brian Matthew Sullivan, North Granby, CT (US); Mikhail Morozov, Norwood, MA (US); Sudarshan N. Koushik, West Hartford, CT (US)

(21) Appl. No.: 18/183,778

(22) Filed: Mar. 14, 2023

Related U.S. Application Data
(60) Provisional application No. 63/269,639, filed on Mar. 21, 2022.

(51) Int. Cl. A62C 31/02; B05B 1/00; B05B 15/40

(52) U.S. Cl. CPC A62C 31/02; B05B 1/002; B05B 15/40

(57) ABSTRACT

A nozzle assembly for a fire suppression system is disclosed. In some embodiments, the nozzle assembly comprises a body having an inlet end for receiving a flow of fire extinguishing agent from the fire suppression system at an inlet pressure; a nozzle portion extending from the body and having an interior cavity; and a conical central body located in the interior cavity, extending upstream from a base of the nozzle portion, wherein a plurality of exit orifices are formed in an outer wall of the nozzle portion, in communication with the interior cavity, for vectoring the flow of fire extinguishing agent exiting therefrom.

### CROSS-REFERENCE TO RELATED APPLICATIONS

The application claims the benefit of U.S. Provisional Application No. 63/269,639 filed Mar. 21, 2022, the contents of which are hereby incorporated in their entirety.

### BACKGROUND

The invention relates generally fire suppression systems, and more particularly, to a low noise nozzle assembly for use with a fire suppression system.

Data centers are generally used to store and distribute valuable information across many industries. Industry demands that these data centers remain continuously functional. Downtime can damage the reputation of a data center and result in the loss of customers. Information handled by data centers is primarily stored on magnetic Hard Disk Drives (HDDs). These hardware devices have a known sensitivity to sound, that is, sound pressure can cause vibration-induced damage or disruptions to an HDD. Unfortunately, inert gas fire suppression systems typically used to protect the server rooms that house this type of equipment in a data center, utilize nozzles that can produce sound levels which may have an adverse effect on this noise sensitive hardware. Some common nozzles generate noise levels in excess of 130 dB, which creates an unacceptable risk of lost operation time for a data center.

### BRIEF DESCRIPTION

Aspects of the disclosure relate to low noise nozzle assembly for fire suppression systems.

In some embodiments, a nozzle assembly for a fire suppression system comprises a body having an inlet end for receiving a flow of fire extinguishing agent from the fire suppression system at an inlet pressure a nozzle portion extending from the body and having an interior cavity; and a conical central body located in the interior cavity, extending upstream from a base of the nozzle portion, wherein a plurality of exit orifices are formed in an outer wall of the nozzle portion, in communication with the interior cavity, for vectoring the flow of fire extinguishing agent exiting therefrom.

In some embodiments, nozzle portion has a cylindrical outer wall, and wherein the exit orifices are defined in the cylindrical outer wall of the nozzle portion.

In some embodiments, the exit orifices formed in the cylindrical outer wall of the nozzle portion are oriented at an angle that is perpendicular to the cylindrical outer wall of the nozzle portion.

In some embodiments, the inlet end of the body portion is axially aligned with the nozzle portion along a central axis thereof.

In some embodiments, the exit orifices formed in the cylindrical outer wall of the nozzle portion are oriented at an angle that is perpendicular to the central axis of the nozzle portion.

In some embodiments, the nozzle assembly comprises at least one perforated filter member positioned upstream from the exit orifices formed in the nozzle portion, the perforated filter member configured for reducing the inlet pressure of the fire extinguishing agent.

In some embodiments, the at least one perforated filter member is formed from a perforated metal plate.

In some embodiments, the at least one perforated filter member is a cylindrical perforated filter member that is coaxially positioned within the cylindrical nozzle portion.

In some embodiments, the at least one perforated filter member includes a plurality of perforated filter members positioned within the interior cavity of the nozzle portion in spaced apart relationship along a central axis thereof.

In some embodiments, each of the plurality of perforated filter members has the same porosity.

In some embodiments, each of the plurality of perforated filter members has a different porosity.

In some embodiments, the plurality of perforated filter members decreases in porosity in a downstream direction along the central axis of the nozzle portion.

In some embodiments, a porous metal foam insert is positioned upstream from the at least one perforated filter member.

In some embodiments, a plurality of porous metal foam inserts are positioned upstream from each perforated filter member.

In some embodiments, the inlet end of the body portion includes a metering orifice.

In some embodiments, the exit orifices formed in the cylindrical outer wall of the nozzle portion vary in diameter along the central axis of the nozzle portion in a downstream direction.

In some embodiments, nozzle assembly for a fire suppression system comprises a body having an inlet end for receiving a flow of fire extinguishing agent from the fire suppression system at an inlet pressure; a nozzle portion axially aligned with the inlet end of the body along a central axis thereof; and a conical central body located in the interior cavity, extending upstream from a base of the nozzle portion, wherein a plurality of exit orifices are formed in a cylindrical outer wall of the nozzle portion for vectoring the flow of fire extinguishing agent exiting therefrom, wherein a cross-sectional area of the nozzle portion at any axial point along the central axis thereof is equal to a total open area of the exit orifices formed in the cylindrical outer wall of the nozzle portion downstream from that axial point.

In some embodiments, at least one perforated filter member is positioned upstream from the exit orifices formed in the nozzle portion, for reducing the inlet pressure of the fire extinguishing agent.

In some embodiments, a porous metal foam insert is positioned upstream from the at least one perforated filter member.

In some embodiments, a metering orifice is positioned upstream from the at least one perforated filter member.

Various other aspects, features, and advantages of the invention will be apparent through the detailed description of the invention and the drawings attached hereto. It is also to be understood that both the foregoing general description and the following detailed description are examples and not restrictive of the scope of the invention.

### BRIEF DESCRIPTION OF THE DRAWINGS

FIG. 1 is a perspective view of a server room in a data center that is protected by a fire suppression system including a low noise nozzle, in accordance with one or more embodiments.

FIG. 2 is a perspective view of an example of a low noise nozzle, in accordance with one or more embodiments.

FIG. 3 is a cross-sectional view of an example of a low noise nozzle, in accordance with one or more embodiments.

FIG. 4 shows an example of fire extinguishing agent flowing out of a low noise nozzle, in accordance with one or more embodiments.

FIG. 5 is a cross-sectional view of an example of a low noise nozzle, in accordance with one or more embodiments.

FIG. 6 is a front plan view of a perforated filter member, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

The present disclosure is related to U.S. Non-Provisional patent application Ser. No. 17/264,145, filed 1 Aug. 2019 which claims the benefit of U.S. Provisional Patent Application US 62/713,609, filed 2 Aug. 2018. The entire content of each of these applications is incorporated by reference in its entirety.

The present disclosure, in accordance with some embodiments, is directed to a new and useful nozzle assembly for a fire suppression system that does not generate sound levels that are high enough to have an adverse effect on magnetic HDDs. The nozzle assembly includes a body having an inlet end for receiving a flow of fire extinguishing agent from the fire suppression system at an entrance velocity and inlet pressure. In some embodiments, the nozzle assembly may include a cylindric outer wall and a conical center body located inside a cavity of the nozzle assembly. The cylindric shape of the nozzle assembly and the conical center body may help maintain uniform pressure within the nozzle assembly and may produce lower noise levels that would protect data centers without risk of lost operation time.

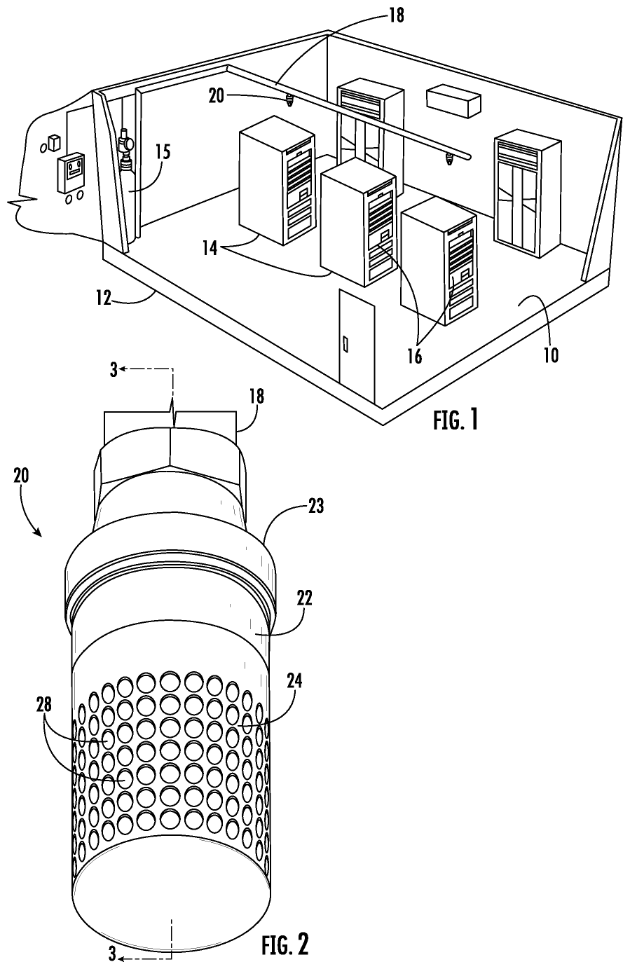

FIG. 1 is a perspective view of a server room 10 in a data center that is protected by a fire suppression system including a low-velocity nozzle, in accordance with one or more embodiments. In some embodiments, server room 10 is located in a data center 12, which houses racks 14 containing hard disk drives 16, and a fire suppression system 18 for protecting the server room 10 in the event of the detection of a hazardous condition such as smoke, excessive heat, or fire. In some embodiments, fire suppression system 18 may include a storage tank 15 containing an inert gas fire suppressant, such as argon. The fire suppression system 18 may further include one or more low-velocity acoustic noise reduction nozzle assemblies 20 constructed in accordance with one or more embodiments of the invention. In some embodiments, the one or more low-velocity acoustic noise reduction nozzle assemblies 20 may be configured to discharge the fire suppressant contained in storage tank 15 into the server room 10 in the event of the detection of a hazardous condition.

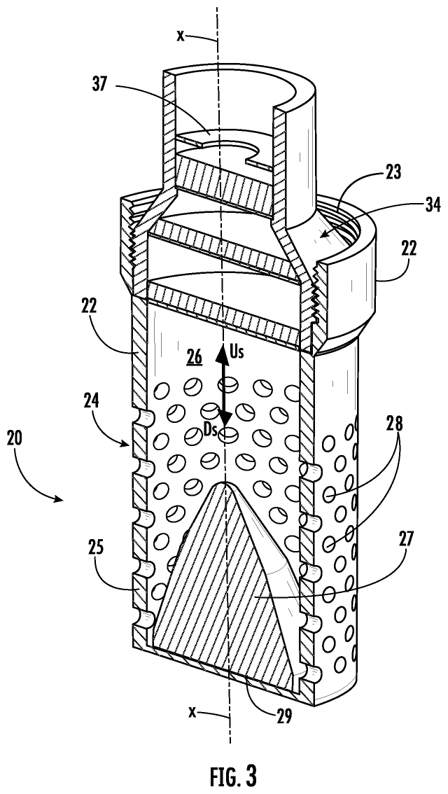

FIG. 2 illustrates a perspective view of a low-velocity nozzle 20 according to one or more embodiments. In some embodiments, nozzle assembly 20 may include a body 22 having an inlet end 23 for receiving a flow of fire extinguishing agent from the fire suppression system 18. In some embodiments, inlet end 23 may be configured to receive the flow of fire extinguishing agent at an entrance mass flow of about between 0.1 and 0.5 kg/s (e.g., 0.3 kg/s) and inlet pressure of about between 60 to 70 psig (e.g., 66 psig). The body 22 of nozzle assembly 20 may further include an axially extending nozzle portion 24. A plurality of exit orifices 28 are formed through the nozzle portion 24 for efficiently vectoring the flow of fire extinguishing agent exiting therefrom as described below.

FIG. 3 illustrates a cross-sectional view of the nozzle taken along line 3-3 of FIG. 2. The axially extending nozzle portion 24 of nozzle assembly 20 has a cylindrical outer wall 25 and an interior cavity 26 that defines a central longitudinal axis extending along line X-X in upstream direction Us and downstream direction Ds. A plurality of exit orifices 28 are formed in the cylindrical outer wall 25 of nozzle portion 24 for efficiently vectoring the flow of fire extinguishing agent exiting therefrom and to effectively reduce the acoustic noise level of the nozzle assembly 20. Moreover, the exit orifices 28 formed in the cylindrical outer wall 25 of nozzle portion 24 may help reduce the overall acoustic signature of the nozzle assembly 20.

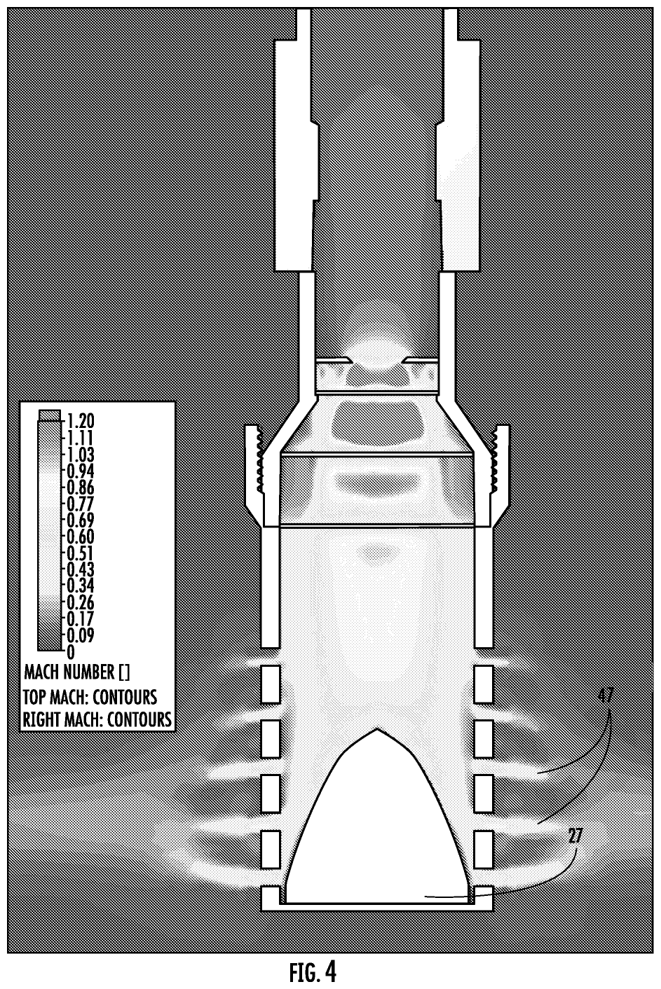

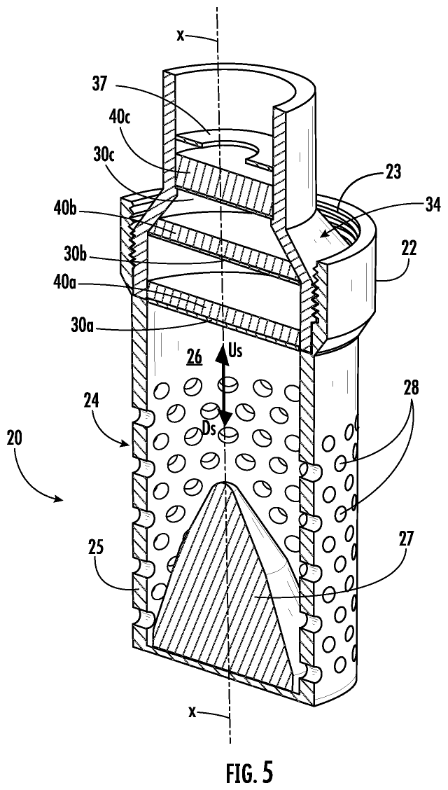

In some embodiments, interior cavity 26 may include a conical central body 27. In some embodiments, conical central body 27 extends along line X-X from a base 29 of nozzle portion 24 in upstream direction Us. In some embodiments, conical central body 27 may be configured to distribute the flow of fire suppressant radially in an approximatively horizontal direction as shown in FIG. 4. FIG. 4 shows an example of fire extinguishing agent flow out of a low noise nozzle, in accordance with one or more embodiments. The conical central body 27 is configured to distribute the flow of fire suppressant radially in an approximatively horizontal direction 47. In some embodiments, conical central body 27 may be configured such that the flow of fire extinguishing agent in approximately 360-degree cylindrical pattern. In some embodiments, conical central body 27 may help reduce the pressure while evenly distributing the flow throughout the internal cross-sectional area, and reducing the noise associated with flow turbulence.

In some embodiments, conical central body 27 may be configured to extend in the upstream direction between about a quarter of nozzle portion 24 and highest point of exit orifices 28. In some embodiments, conical central body 27 may extend upstream to about location of highest exit orifices. In some embodiments, conical central body 27 may be made from a metal similar to the metal of the nozzle portion 24. In some embodiments, conical central body 27 may be a hollow, partially filled, or solid structure. In some embodiments, conical central body 27, may be configured to connect to base 29 of nozzle portion 24. In some embodiments, conical central body 27, may be configured to connect to one or more inner sides of the nozzle portion 24.

In some embodiments, the exit orifices 28 defined in the cylindrical outer wall 25 of the nozzle portion 24 may be oriented at an angle relative to the axial plane X-X. For example, in some embodiments, the exit orifices 28 may be oriented at an angle that is perpendicular to the central axis X-X of the nozzle portion 24 so as to control fluid vectoring in an approximately horizontal manner. Alternatively, the exit orifices 28 can be oriented at other angles so as to control fluid vectoring in another preferred manner, which would depend upon the configuration of the area to be protected by the nozzle assembly 20. In some embodiments, exit orifices 28 in the outer wall 25 could all be oriented at the same angle or they could be oriented at different angles relative to the axial plane X-X of the nozzle portion 24.

It is also envisioned that the exit orifices 28 in the cylindrical outer wall 25 of the nozzle portion 24 could vary in diameter and/or in number along the central axis X-X of the nozzle portion 24. For example, the upstream exit orifices 28 can have a diameter “D” while the downstream exit orifices 28 can have a smaller diameter “d”. Those skilled in the art will readily appreciate that the frequency of the noise generated by the nozzle assembly 20 will increase as the exit orifices 28 decrease in size. Accordingly, the diameter of the exit orifices 28 should be sized so as to minimize the overall acoustic signature of the nozzle assembly 20, while maintaining a preferred coverage volume of about 100 m³.

Furthermore, the nozzle portion 24 is preferably dimensioned and configured so that the cross-sectional area thereof at any point along the central axis X-X is equal to the total open area of the exit orifices 28 formed in the conical outer wall 25 of the nozzle portion 24 downstream from that point. Consequently, the static pressure within the interior cavity 26 of the nozzle portion 24 will be maintained at a level that will ensure that fire extinguishing agent is uniformly fed to all of the exit orifices 28 for the entire duration of the discharge, which could range from 60 seconds to 120 seconds.

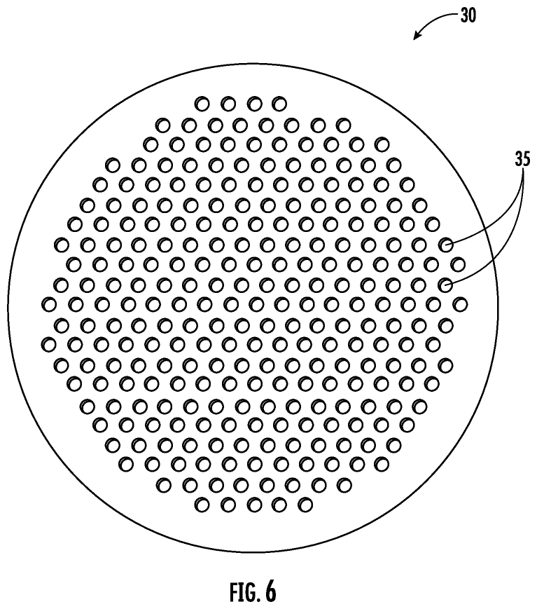

In some embodiments, a perforated filter member 30 (shown in FIG. 6) may be positioned within the interior cavity 26 of the nozzle portion 24, upstream from the exit orifices 28 formed in the cylindrical outer wall 25, for reducing the entrance velocity of the fire extinguishing agent, which may further help reduce the acoustic noise level. In some embodiments, the perforated filter member 30 may help lower the pressure of the incoming flow before entering the nozzle portion 24, by dropping the inlet pressure (e.g., by about 60 psig to an exit pressure of about 2 psig) to avoid supersonic jet flow through the nozzle assembly 20. In some embodiments, as a result of the perforated filter member 30 advantageously lowering the velocity and pressure of the incoming flow of fire suppressant, in combination with the exit orifices 28 lowering the acoustic signature of the nozzle assembly 20, the nozzle assembly may have a resulting noise level of less than 110 db. Those skilled in the art will readily appreciate that achieving such a noise level will not cause damage or disruption to the HDDs 16 that are located within the server room of a data center 12 in the event of a fire.

FIG. 6 shows a front plan view of a perforated filter member 30, in accordance with one or more embodiments. In some embodiments, perforated filter member 30 may be in the form of a perforated metal plate. In some embodiments, the perforated metal plate of filter member 30 may be made from aluminum or a similar light-weight metal. For example, in some embodiments, the perforated filter member 30 may have a thickness of about 1/16th of an inch. In some embodiments, about 20% to 40% of the surface area of the perforated filter member 30 may be defined by open space. For example, the perforated filter member 30 may be defined by about 23% open space formed by a multiplicity of apertures 35.

Returning to FIG. 3, in some embodiments, the inlet end 23 of the body 22 of nozzle assembly 20 may include a threaded flange 32, which is configured for operative engagement with a diffuser portion 34. In some embodiments, the diffuser portion 34 may include a threaded fitting configured to engage with threaded flange 32. In some embodiments, diffuser portion may have a conventional NPT format that is adapted to communicate with the fire suppression system 18. In some embodiments, the diffuser portion 34 may include a metering orifice plate 37. In some embodiments, filter member 30 of FIG. 6 may be supported or otherwise firmly retained within the interior cavity 26 of the body 22 of nozzle assembly 20.

FIG. 5 is a cross-sectional view of nozzle assembly 20, in accordance with one or more embodiments. In some embodiments, the nozzle assembly 20 could include a two or more perforated filter members in spaced apart relationship along the central axis X-X thereof. For example, as can be seen in FIG. 5, the nozzle assembly 20 may include three spaced apart filter members. For example, in some embodiments, nozzle assembly may include a downstream perforated filter member 30a positioned within the interior cavity 26, a second perforated filter member 30b positioned upstream from member 30a, and an upstream perforated filter member 30c positioned within the diffuser section and upstream from filter member 30b.

In some embodiments, a porous metal foam insert could be associated with an upstream side of each of the perforated filter members 30a, 30b, and 30c to further reduce the inlet pressure of the fire suppressant. More particularly, a porous metal foam insert 40a would be associated with an upstream side of perforated filter member 30a, a porous metal foam insert 40b would be associated with an upstream side of the perforated filter member 30b, and a porous metal foam insert 40c would be associated with an upstream side of the perforated filter member 30c. In some embodiments, the porous metal foam inserts are about 0.5 inches in thickness. In some embodiments, when used alone or in combination with one another, these porous components may function to reduce the pressure while evenly distributing the flow throughout the internal cross-sectional area, and reducing the noise associated with flow turbulence. In some embodiments, when the porous components/perforated metal foam are used just downstream of a metering orifice, they may function to effectively reduce the noise associated with supersonic flow by dissipating the shock formed downstream of the metering orifice.

While the perforated filter members 30a, 30b, and 30c preferably have the same porosity, it is envisioned that each of a plurality of perforated filter members could have a different porosity. For example, in such an embodiment, the perforated filter members 30a, 30b, and 30c would decrease in porosity in a downstream direction Ds along the axis X-X of the interior cavity 26 so as to gradually or otherwise progressively reduce the flow velocity of the fire suppression agent in a stepwise or multi-staged manner. For example, in some embodiments, the upstream filter member 30a could be a perforated metal plate having a porosity of about 40%. In some embodiments, filter member 30b could be a perforated metal plate having a porosity of about 30%. In some embodiments, embodiments, filter member 30b could be a perforated metal plate having a porosity of about 20%. It is also envisioned that in some embodiments, the porosity of the filter members 30a, 30b, and 30c may be the same.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A nozzle assembly for a fire suppression system, comprising:
a body having an inlet end for receiving a flow of fire extinguishing agent from the fire suppression system at an inlet pressure;
a nozzle portion extending from the body and having an interior cavity; and
a conical central body located in the interior cavity, extending upstream from a base of the nozzle portion, wherein a plurality of exit orifices are formed in an outer wall of the nozzle portion, in communication with the interior cavity, for vectoring the flow of fire extinguishing agent exiting therefrom.

2. The nozzle assembly of claim 1, wherein the nozzle portion has a cylindrical outer wall, and wherein the exit orifices are defined in the cylindrical outer wall of the nozzle portion.

3. The nozzle assembly of claim 2, wherein the exit orifices formed in the cylindrical outer wall of the nozzle portion are oriented at an angle that is perpendicular to the cylindrical outer wall of the nozzle portion.

4. The nozzle assembly of claim 2, wherein the inlet end of the body portion is axially aligned with the nozzle portion along a central axis thereof.

5. The nozzle assembly of claim 4, wherein the exit orifices formed in the cylindrical outer wall of the nozzle portion are oriented at an angle that is perpendicular to the central axis of the nozzle portion.

6. The nozzle assembly of claim 1, comprising:
at least one perforated filter member positioned upstream from the exit orifices formed in the nozzle portion, the perforated filter member configured for reducing the inlet pressure of the fire extinguishing agent.

7. The nozzle assembly of claim 6, wherein the at least one perforated filter member is formed from a perforated metal plate.

8. The nozzle assembly of claim 6, wherein the at least one perforated filter member is a cylindrical perforated filter member that is coaxially positioned within the cylindrical nozzle portion.

9. The nozzle assembly of claim 6, wherein the at least one perforated filter member includes a plurality of perforated filter members positioned within the interior cavity of the nozzle portion in spaced apart relationship along a central axis thereof.

10. The nozzle assembly of claim 9, wherein each of the plurality of perforated filter members has the same porosity.

11. The nozzle assembly of claim 9, wherein each of the plurality of perforated filter members has a different porosity.

12. The nozzle assembly of claim 9, wherein the plurality of perforated filter members decrease in porosity in a downstream direction along the central axis of the nozzle portion.

13. The nozzle assembly of claim 6, wherein a porous metal foam insert is positioned upstream from the at least one perforated filter member.

14. The nozzle assembly of claim 9, wherein a plurality of porous metal foam inserts are positioned upstream from each perforated filter member.

15. The nozzle assembly of claim 1, wherein the inlet end of the body portion includes a metering orifice.

16. The nozzle assembly of claim 2, wherein the exit orifices formed in the cylindrical outer wall of the nozzle portion vary in diameter along the central axis of the nozzle portion in a downstream direction.

17. A nozzle assembly for a fire suppression system, comprising:
a body having an inlet end for receiving a flow of fire extinguishing agent from the fire suppression system at an inlet pressure;
a nozzle portion axially aligned with the inlet end of the body along a central axis thereof;
a conical central body located in the interior cavity, extending upstream from a base of the nozzle portion, wherein a plurality of exit orifices are formed in a cylindrical outer wall of the nozzle portion for vectoring the flow of fire extinguishing agent exiting therefrom, wherein a cross-sectional area of the nozzle portion at any axial point along the central axis thereof is equal to a total open area of the exit orifices formed in the cylindrical outer wall of the nozzle portion downstream from that axial point.

18. The nozzle assembly of claim 17, wherein at least one perforated filter member is positioned upstream from the exit orifices formed in the nozzle portion, for reducing the inlet pressure of the fire extinguishing agent.

19. The nozzle assembly of claim 18, wherein a porous metal foam insert is positioned upstream from the at least one perforated filter member.

20. The nozzle assembly of claim 18, wherein a metering orifice is positioned upstream from the at least one perforated filter member.
